(19) United States
(12) Patent Application Publication
(10) Pub. No.: US 2017/0154391 A1
(43) Pub. Date: Jun. 1, 2017

(54) SYSTEM FOR RESOURCE ANALYSIS AND RESOLUTION OF NON-CONFORMING ATTRIBUTES

(71) Applicant: BANK OF AMERICA CORPORATION, Charlotte, NC (US)

(72) Inventors: Gary John Watkins, Charlotte, NC (US); Teri Elizabeth Howes, Lake Forest, CA (US); Robert A. Valentini, Charlotte, NC (US); Tamara Moore Thompson, Huntersville, NC (US)

(21) Appl. No.: 14/954,921

(22) Filed: Nov. 30, 2015

(51) Int. Cl. G06Q 50/18

(52) U.S. Cl. CPC G06Q 50/18

(57) ABSTRACT

The present invention provides for computational analysis of resources to determine if the attributes associated with the resource deviate from core/standard resource attributes associated with resources of the same or similar resource category. In response to determining one or more deviations, a level of deviation is quantified for the resource based on the determined deviation of the attributes associated with the resource to the core resource attributes. Based on the level of deviation, a resolution scenario/path is invoked for the resource and further transformation of the resource may be required based on resource requirements associated with the resource, resource category and/or resource controlling-entity.

### FIELD

In general, embodiments of the invention relate to computing networks and, more particularly, systems, methods and the like for resource analysis and resolution of non-conforming attributes.

### BACKGROUND

In a large enterprise environment many resources may exist that may pose a threat or otherwise expose the enterprise to legal or regulatory peril. For example, in a large enterprise thousands of contracts may exist with third party entities and the like, which may have material terms (e.g., legal and/or regulatory terms). The enterprise may not be aware of the legal and/or regulatory exposure resulting from some, if not all, of the multitude of contracts that are active. This is especially true in enterprises that have undergone acquisitions and/or mergers and, as a result, have acquired resources, such as contracts and the like, from the acquired or merged entity. In such instances, the contracts inherited from merged or acquired entities will typically have different material terms than the conventional enterprise contracts and the enterprise is likely to be unaware of the legal and/or regulatory ramifications resulting from such disparate material terms.

Moreover, large enterprises may have a desire to consolidate the third-party entities (i.e., vendors or the like) which they have contractual obligations with. In instances in which the third-party entities perform their obligations relatively equally, material terms in the contracts, such as what legal and regulatory terms the third party is obligated to perform, may be a differentiating factor in determining which third party entities should remain as vendors and which are candidates for consolidation.

Therefore, a need exists to develop systems, apparatus, computer program products, methods and the like that provide computational analysis of resources and resolution of non-conforming attributes. Specifically, a need exists to analyze contracts entered into by an enterprise to identify material terms, such as legal or regulatory terms that pose a threat or otherwise place a level of exposure on the enterprise and to subsequently accept, resolve or terminate the exposure through accepting the contract as is, remediating/renegotiating the contract or terminating the contract.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for providing computational analysis of resources and resolution of non-conforming attributes. In this regard, resources are assessed/evaluated to identify a plurality of attributes associated with a resource of a specified resource category and a core resource attribute database is accessed to determine the deviation of the attributes associated with the resource to the core attributes for the identified resource category. In response to determining the deviation between the attributes associated with the resource and the core attributes, an overall level of deviation is determined for the resource and, in response to determining the level of deviation, a resolution scenario is invoked for the resource based on the level of deviation.

In specific embodiments of the invention, the computational analysis of the resource involves assessment of contracts, specifically the material terms in the contracts, such as the legal and/or regulatory terms and the like. The contracts are assessed by comparing the material terms in the contract to the standard or core material terms in similar contracts (i.e., contracts for the same product or service, otherwise referred to herein as, same category of contract). In specific embodiments of the invention, such assessment is conducted by presenting a user/assessor with a series of questions related to the material terms and receiving inputs that answer the question, as well as provide support for the answer (i.e., identification of location in the contract) and the rationale for the answer (i.e., the cognitive reasoning for the answer and the specific contract language to support the answer). Each answer to a corresponding material term-related question will result in determination of a corresponding contract term rating (i.e., a numerical value or the like) for that particular question. The contract term rating is typically weighted for each category of contracts based on how significant the particular contract term is to the associated category of contracts. In response to completing the series of questions a cumulative/overall quantifiable level of exposure (i.e. exposure rating or the like) is determined for the contract. In specific embodiments a second level of contract assessment is conducted (referred to as a quality assurance check) to assure accuracy of the answers and, thus resulting level of exposure. In response to determining the overall level of exposure of the contract, the contract undergoes exposure decisioning in which the contract either is accepted as is, remedial action (e.g., renegotiation of the contract) is taken on the contract or the contract is terminated.

A system for computational analysis of resources to determine attribute deviation from core resource attributes defines first embodiments of the invention. The system includes a core resource attribute database/warehouse configured to store, in first memory, a plurality core attributes for each of a plurality of resource categories. In addition, the system includes an apparatus including a computing platform having a second memory and at least one processor device in communication with the second memory. Additionally, the system includes a resource analytics module that is stored in the second memory and executable by the processor device. The resource analytics module is configured to receive a plurality of first inputs that assess a plurality of attributes associated with a resource of an identified resource category and access the core resource attribute database to determine deviation of the attributes associated with the resource to the core attributes for the identified resource category. Further, in response to determining the deviation of the attributes, the contracts analytics module is configured to determine a level of deviation for the resource (i.e., an overall deviation rating for the resource) and, in response to determining the level of deviation, invoke a resolution scenario for the resource based on the level of deviation.

In specific embodiments the system further includes a central reporting repository configured to store, in a third memory, the resolution scenario for each of a plurality of resources. In further specific embodiments the system includes a requirement rules database configured to store, in fourth memory, a plurality of compliance requirement rules associated each of the plurality of resource categories. In such embodiments of the system, the central reporting repository may be further configured to access the requirement rules database to apply compliance requirement rules applicable to the identified resource category and, based on application of the compliance requirement rules, transform the resource to comply with the compliance requirement rules.

In further specific embodiments of the system, the resource analytics module may be further configured to receive one or more second inputs that assess one or more attributes associated with a sub-resource of the resource and determine that at least one of the one or more second inputs result in a conflict between one or more attributes associated with the sub-resource and one or more attributes associated with the resource. In response to determining the conflict, the resource analytics module is further configured to determine the level of deviation for the resource based on the conflict between one or more attributes associated with the sub-resource and one or more attributes associated with the resource.

A system for computational analysis of contracts for identifying contract exposure defines second embodiments of the invention. The system includes a contract term rating database that is configured to store, in first memory, contract term ratings for a plurality of material contract terms based on an associated contract category. The system additionally includes an apparatus including a computing platform having a second memory and at least one processor device in communication with the second memory. In addition the system includes a contracts analytics module that is stored in the second memory and executable by the processor device.

The contracts analytics module is configured to receive a plurality of first inputs that assess a plurality of material terms associated with a contract of an identified contract category. In specific embodiments of the system the first inputs include (i) answers to a plurality of material term-related questions, and, optionally, (ii) a location in the contract that supports a corresponding answer to a material term-related question, and (iii) rationale for a corresponding answer to a material term-related question. In such embodiments the rationale for a corresponding answer may include (a) cognitive process behind the corresponding answer, and (b) the specific language in the contract that supports the corresponding answer.

In response to receiving the first inputs, the contracts analytics module is further configured to access the contract term rating database to determine, based on the first inputs, contract term ratings for one or more of the plurality of material terms associated with the contract. In specific embodiments of the invention, the contract term rating database is accessed each time an answer to one of the plurality of material-term related questions is received to determine/identify the contract term rating associated with the answer. Moreover, in specific embodiments, each contract term rating is a pre-determined weighted value, such that the weighting is based on a relative importance of the material contract term to the associated contract category.

In response to determining the contract term ratings, the contracts analytics module is further configured to determine a quantifiable level of exposure for the contract (i.e., an overall exposure rating for the contract) based on the contract term ratings. In specific embodiments of the system, the contracts analytics module is configured to determine/update the level of exposure/exposure rating, in real-time, in response to receiving each of the answers to the plurality of material-term related questions.

In alternate embodiments of the system, the contracts analytics module is further configured to receive one or more of second inputs that re-assess (i.e., provide a quality assurance check) for one or more of the plurality of material terms associated with the contract.

In still further alternate embodiments of the system, the contracts analytics module is further configured to receive one or more of second inputs that assess one or more of the plurality of material terms associated with a sub-contract (i.e., an amendment to the contract, sub-agreement, addendum, codicil or the like) of the contract. In such embodiments, the contracts analytics module is configured to determine that at least one of the one or more second inputs result in a conflict between one or more material terms associated with the sub-contract and one or more material terms associated with the contract (i.e., a conflict between answers provided to questions provided for the sub-contract versus answers provided to questions in the primary contract). In response to determining the conflict, the contracts analytics engine is further configured to access the contract term rating database to determine, based on the conflict, contract term ratings for one or more of the plurality of material terms associated with the sub-contract and, in response to confirming that that the sub-contract amends the contract, re-determine (i.e., re-calculate or update) the level of exposure (i.e., the exposure rating) for the contract based on the contract term ratings for one or more of the plurality of material terms associated with the sub-contract.

In other specific embodiments of the system, the contracts analytics module is further configured to automatically re-determine (i.e., re-calculate or update) the level of exposure, in real-time, in response to one or more events that change a status of the contract or the sub-contract (e.g., an occurrence of a sub-contract closing that results in amendment to the primary contract, wherein the material terms of the sub-contract amend the material terms of the primary contract).

In still further embodiments of the system, the contracts analytics module is further configured to present the quantifiable level of exposure and first inputs to a decisioning entity and receive one or more second inputs from the decisioning entity that determines if the contract is (i) acceptable as is, (ii) requires remediation (e.g., re-negotiation or the like), or (iii) requires termination of the contract.

A computer program product including a non-transitory computer-readable medium defines third embodiments of the invention. The computer-readable medium includes a first set of codes for causing a computer receive a plurality of first inputs that assess a plurality of material terms associated with a contract of an identified contract category. In addition, the computer-readable medium includes a second set of codes for causing a computer to access a contract term rating database to determine, based on the first inputs, contract term ratings for one or more of the plurality of material terms associated with the contract. Further, the computer-readable medium includes a third set of codes for causing a computer to determine a quantifiable level of exposure for the contract based on the contract term ratings.

Thus, systems, apparatus, methods, and computer program products herein described in detail below provide for computational analysis of resources, such as contracts, and resolution of non-conforming attributes, such as material terms of the contracts. In this regard, resources are assessed/evaluated to identify a plurality of attributes associated with a resource of a specified resource category and a core resource attribute database is accessed to determine the deviation of the attributes associated with the resource to the core attributes for the identified resource category. In response to determining the deviation between the attributes associated with the resource and the core attributes, an overall level of deviation is determined for the resource and, in response to determining the level of deviation, a resolution scenario is invoked for the resource based on the level of deviation.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a bock diagram of a system for computational analysis of resources and resolution of non-conforming attributes, in accordance with embodiments of the present invention;

FIG. 2 provides a block diagram of a system for computational analysis of contracts for identifying and quantifying contract exposure, in accordance with embodiments of the present invention;

FIG. 3 provides a flow diagram of a method for computational analysis of a master contract for identifying and quantifying contract exposure of material terms and optional computational analysis of subcontracts, in accordance with embodiments of the present invention; and

FIGS. 4-15 provide exemplary screen shots of user interfaces implemented in a system for computational analysis of contracts for identifying and quantifying contract exposure, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for computational analysis of resources and resolution of non-conforming attributes associated with the resources. In this regard, resources are assessed/evaluated to identify a plurality of attributes associated with a resource of a specified resource category. In response to identifying the attributes, a core resource attribute database is accessed to determine the deviation of the attributes associated with the resource to the core attributes for the identified resource category. In response to determining the deviation of the attributes associated with the resource to the core attributes, an overall level of deviation is determined for the resource and, in response to determining the level of deviation, a resolution scenario is invoked for the resource based on the level of deviation.

In specific embodiments of the invention, the computational analysis of the resource involves assessment of contracts, specifically the material terms in the contract, such as the legal and/or regulatory terms and the like. The contracts are assessed by comparing the material terms in the contract to the standard or core material terms in similar contracts (i.e., contracts for the same product or service, otherwise referred to herein as, same category of contract). In specific embodiments of the invention, such assessment is conducted by presenting a user/assessor with a series of questions related to the material terms and receiving inputs that answer the questions, as well as provide support for the answer (i.e., identifies location in the contract) and the rationale for the answer (i.e., the cognitive reasoning for the answer and the specific contract language to support the answer). Each answer to a corresponding material term-related question will result in determination of a corresponding contract term rating (i.e., a numerical value or the like) for that particular question. The contract term rating is typically weighted for each category of contracts based on how significant the particular contract term is to the associated category of contracts. In response to completing the series of questions a cumulative/overall quantifiable level of exposure (i.e., exposure rating or the like) is determined for the contract.

In specific embodiments a second level of contract assessment is conducted (referred to as a quality assurance check) to assure accuracy of the answers and resulting level of exposure.

Additionally, in other specific embodiments, subcontracts (also referred to as sub-agreements, amendments, codicils or the like) are assessed by comparing the material terms in the subcontract to the standard or core material terms in similar contracts (i.e., contracts for the same product or service category). In specific embodiments of the invention, such assessment is conducted by presenting a user/assessor with one or more questions that are related to material terms in the subcontract and receiving inputs that answer the one or more questions. In response to answering the question(s), the invention determines if one or more answers to the sub-contract differ from the answer(s) provided for the master contract (otherwise referred to as the contract). If one or more answers are determined to differ and a confirmation is received that the sub-contract amends the master contract, a cumulative/overall level of exposure (i.e., the previously mentioned exposure rating) is re-calculated based on the updated contract term rating(s) associated with the differing answer(s) in the subcontract assessment.

In response to determining the overall level of exposure (i.e., the exposure rating) of the contract, the contract undergoes exposure decisioning in which the contract either is accepted as is, remedial action is taken on the contract (e.g., renegotiation of the contract or the like) or the contract is terminated.

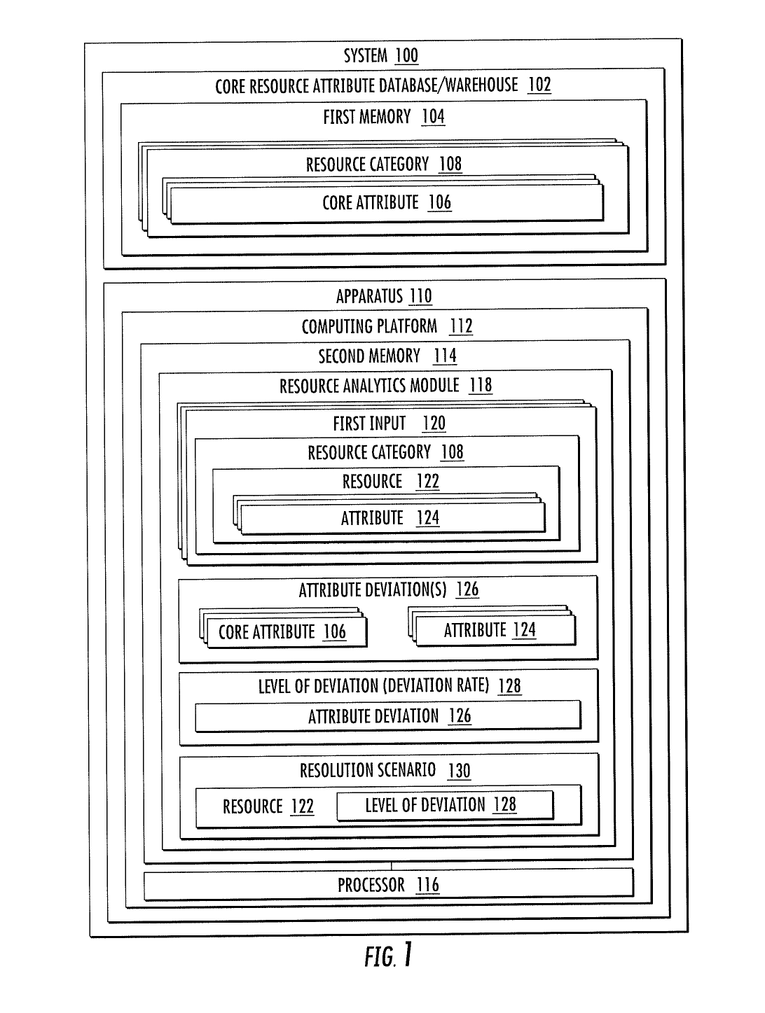

Referring to FIG. 1, a block diagram is provided of a system 100 configured for computational analysis of resources to determine attribute deviation from core resource attributes, in accordance with embodiments of the present invention. The system includes a core resource attribute database/warehouse 102 that stores, in first memory 104, a plurality of core attributes for each of a plurality of resource categories 108. Partitioning of the core attributes on a per-resource category 108 basis, allows for the core attributes to be weighted in terms of their respective importance within the resource category 108. It should be noted that while database 102 is shown as external from resource analytics module 118 in other embodiments of the invention database 102 may be included within resource analytics module 118.

System 100 additionally includes apparatus 110, which may comprise one or more devices. Apparatus 110 includes a computing platform 112 having a second memory 114 and at least one processor 116 in communication with the second memory 114. Second memory 114 stores resource analytics module 118 that is executable by processor 116 and configured to receive first inputs 120 that assess a plurality of attributes 124 within a resource 122 of an identified resource category 108.

In response to assessing the attributes 124, the resource analytics module 118 is further configured to access the core resource attribute database 102 to determine deviations 126 between the attributes 124 within the resource 122 and the core attributes 106.

In response to determining the attribute deviations 126, the resource analytics module 118 is further configured to determine a level of deviation, otherwise referred to as a deviation rating for the resource 122.

Further, in response to determining the level of deviation 128 for the resource 122, the resource analytics module 118 is further configured to invoke a resolution scenario/path 130 for the resource 122 based on the determined level of deviation 128. Optionally, in some embodiments of the invention, the resource analytics module 118 may be further configured to transform the resource 122 based on requirements rules (not shown in FIG. 1) that stipulate which core attributes 106 are required by which resources 122 or resource categories 108.

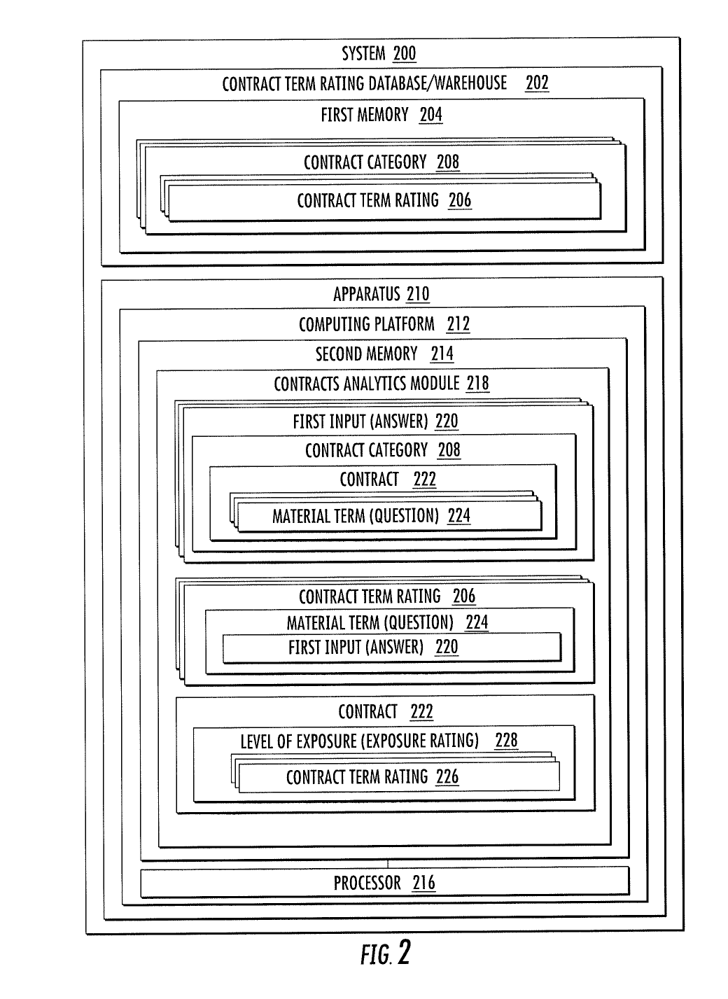

Referring to FIG. 2 shown is a block diagram of a system 200 for computational analysis of contracts within an enterprise for identifying the exposure that a contract poses to the enterprise, in accordance with specific embodiments of the present invention. The system includes a contract term rating database warehouse 202 that stores, in first memory 204, contract term ratings 206 (i.e., numerical values) for a plurality of material contract terms 224 based on an associated contract category 208. In specific embodiments of the invention, the contract term ratings 206 are associated with a corresponding material term-related question presented in the contracts analytics module 218, such that, a user's/assessor's answer to the question will correspond to a specific contract term rating 206 in the database/warehouse 202. Moreover, each contract is assigned to a contract category 208 based on the type of product or service provided by or performed by the associated contract. Contract term ratings 206 are configured to be contract category-specific. In certain embodiments of the invention, when the contract term ratings 206 are applied to a contract, the ratings 206 are weighted based on which contract category 208 the contract is associated with. In this regard, the contract term ratings 206 take into account the relative importance of each contract term based on the contract category 208 associated with the contract (e.g., a contract in a software category may place greater importance on a material term associated with intellectual property indemnification or the like).

System 200 additionally includes apparatus 210, which includes computing platform 212 having second memory 214 and one or more processors 216 in communication with the second memory 214. Moreover, the apparatus 210, may comprise multiple devices, such as multiple servers, storage devices, personal computers and the like.

Second memory 214 may comprise volatile and non-volatile memory, such as read-only and/or random-access memory (RAM), read-only memory ROM, EPROM, EEPROM, flash cards, or any memory common to computer platforms. Further, second memory 214 may include one or more flash memory cells, or may be any secondary or tertiary storage device, such as magnetic media, optical media, tape, or soft or hard disk. Moreover, second memory 214 may comprise cloud storage, such as provided by a cloud storage service and/or a cloud connection service. It should be noted that in certain embodiments of the invention, contract term rating database/warehouse 202 is stored internally within contracts analytics module 218 and, as such, first memory 204 may be included within second memory 214.

Further, processor 216 may be an application-specific integrated circuit (“ASIC”), or other chipset, processor, logic circuit, or other data processing device. Processor 216 or other processor such as ASIC may execute an application programming interface (“API”) (not shown in FIG. 2) that interfaces with any resident programs or modules, such as contracts analytic module 2108 and routines, sub-modules associated therewith or the like stored in second memory 214 of computing platform 212.

Processor 216 includes various processing subsystems (not shown in FIG. 2) embodied in hardware, firmware, software, and combinations thereof, that enable the functionality of apparatus 210 and the operability of the apparatus 210 on a network. For example, processing subsystems allow for initiating and maintaining communications and exchanging data with other networked computing platforms, such as database/warehouse 202 or the like. For the disclosed aspects, processing subsystems of processor 216 may include any subsystem used in conjunction with contracts analytics module 218 and related algorithms, sub-algorithms, modules, sub-modules thereof.

Computer platform 212 may additionally include a communications module (not shown in FIG. 2) embodied in hardware, firmware, software, and combinations thereof, that enables communications among the various components of the computing platform 212, as well as between the other networked devices. Thus, communication module may include the requisite hardware, firmware, software and/or combinations thereof for establishing and maintaining a network communication connection.

Second memory 214 of computing platform 212 stores contracts analytics module 218, that is executable by processor 216 and configured to provide computational analysis of contracts (i.e., legally binding agreements entered into between an enterprise and third party entities/vendors) for the purpose of quantifying the exposure posed by the material terms (e.g., legal and regulatory terms) in the contract, in accordance with embodiments of the present invention.

As previously discussed, large enterprises have a multitude of active contracts at any one point in time and it is difficult for enterprises to assess the threat or exposure that each of the contracts pose to the enterprise based on the material terms that are included (or excluded) in the contracts. Moreover, as large enterprises acquire other entities and/or merge with other entities they acquire the contracts of the merged/acquired entities. These inherited contracts will characteristically include material terms that differ from the conventional material terms in contracts that originated with the enterprise. As such, a need exists to not only identify the threat or exposure posed by each contract but also a means to differentiate contracts based on the level or amount of threat/exposure associated with any given contract.

Contracts analytics module 218 is configured to receive a plurality of first inputs 220 that assess a plurality of material terms 224 associated with a contract 222 of an identified contract category 208. In specific embodiments the first inputs 220 comprise answers to a series of material term-related questions that serve to identify differences between the material terms 224 in the contract 222 and standard/core material terms 224 designated for the particular contract category 208. In specific embodiment of the module 218, the first inputs 220 may include other information that supports the answers to the questions, such as but not limited to, the location (section, page, paragraph or the like) in the contract that supports a corresponding answer and/or the rationale for the corresponding answer. In specific embodiments of the module 210, the rationale may include, but is not limited to, the cognitive process behind the corresponding answer, and/or the specific language (e.g., quotations and the like) in the contract that support the answer. The supporting information serves to provide subsequent quality assurance assessors and/or decisioning entities further support for approving the assessment and/or making the decision on whether the contract should be approved (as is), remediated/re-negotiated or terminated based on the level of exposure.

In response to receiving the first inputs, the contracts analytics module 218 accesses the contract term ratings database 202 to determine/identify the contract term ratings 206 for one or more of the plurality of material terms 224 associated with the contract 222. In specific embodiments of the invention, in which a user/assessor is presented a series of material term-related questions, each answer will correspond with a contract term rating 202 (i.e., numerical value) in the database 202. Answers that indicate that the material term does not differ from the core/standard material term may have a contract rating of zero (0), while answers that indicate a high or highest degree of difference between a material term and a core/standard term may have a higher or highest contract term rating. In addition, as previously discussed, the contract term rating 202 may have a predetermined weighting factor applied (e.g., percentage between 0.0 and 100.0) to the numerical value that indicates the relevant importance of the material term associated with the questions in relation to the contract category that the contract belongs to.

In response to determining/identifying the contract term ratings 226, the contracts analytics module 218 is further configured to determine/calculate a level of exposure 228 (i.e., an exposure rating or score) for the contract 228. In specific embodiments of the invention, the level of exposure/exposure rating 228 is calculated by summing the individual contract term ratings 226 associated with each of the answers to the plurality of questions. In specific embodiments of the invention, the module 218 is configured to calculate the level of exposure/exposure rating 228 after all of the question or all of the mandatory/required questions are answered, while in other embodiments of the invention, the module 218 may be configured to present, in real-time or near real-time, an updated level of exposure/exposure rating 228 each time a first input is received (i.e., each time a questions is answered).

In additional embodiments of the invention, not depicted in FIG. 2, the contracts analytics module 218 may be configured to receive second inputs that re-assess one or more of the plurality of material terms 224 associated with the contract. In this regard, the re-assessment serves as a quality assurance check by a second user/assessor that verifies the accuracy of the first inputs 220 and, in the event that a first input is found to be inaccurate, the second input overrides or otherwise replaces the first input 220 (i.e., the re-assessment changes the answer to one or more of the previously answered questions). In specific embodiments the re-assessment/quality assurance check may occur prior to determining the level of exposure/exposure rating 228 or, in other embodiments, the re-assessment/quality assurance check may occur after determining the level of exposure/exposure rating 228, in which case second inputs that change an answer would result in a re-determination/re-calculation of the level of exposure/exposure rating 228.

In response to determining the level of exposure/exposure rating 228, the contract is queued for decisioning by an authorized decisioning entity and the decisioning process results in the contract either being accepted as is, identified as requiring remediation/re-negotiation, or terminated.

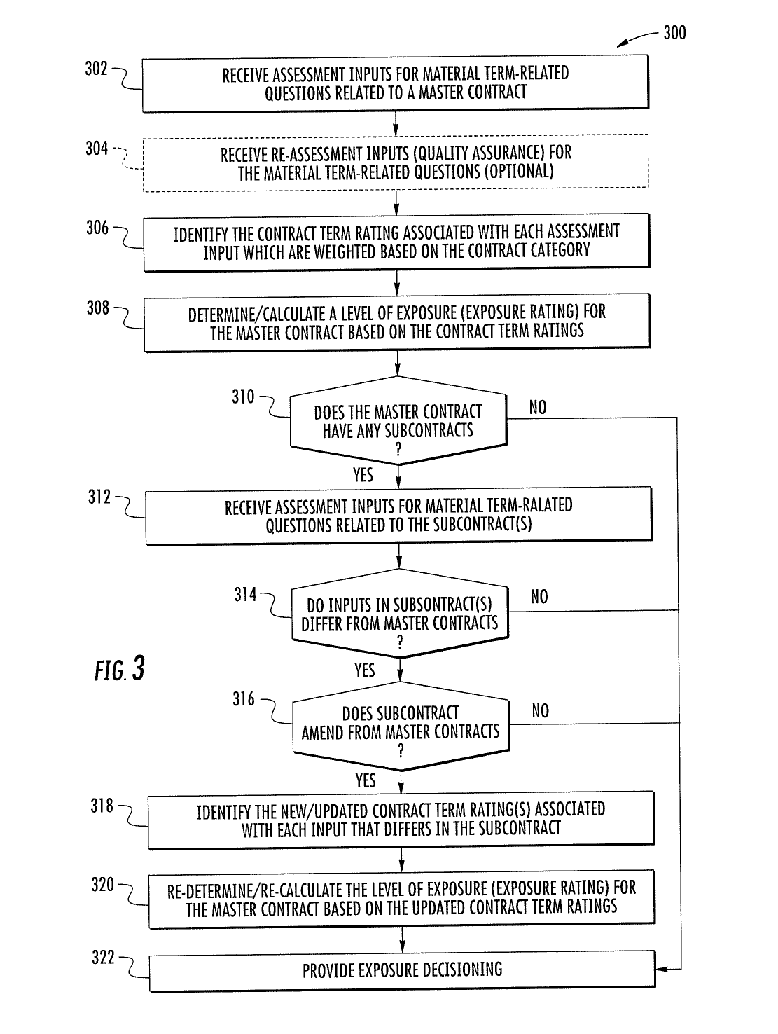

Referring to FIG. 3 a flow diagram is presented of a methodology 300 for computational analysis of contracts within an enterprise for identifying the exposure that a contract poses to the enterprise, in accordance with specific embodiments of the present invention. At Event 302 assessment inputs (i.e., answers) are received for material term-related questions related to a master contract. The material terms may include, but are not limited to, legal and regulatory terms of a contract. In specific embodiments of the invention, assessment inputs are received for those material term-related questions that are predetermined to be mandatory or required. The user-interface that presents the questions may indicate mandatory or required through a visual indicator such, as color-coding, highlighting or the like. The assessment inputs/answers that are inputted by a user/assessor are based on a comparison of the material terms in the master contract to the standard/core terms present in contracts of this type (i.e., same contract category).

At optional Event 304, re-assessment inputs (i.e., quality assurance verification checks) are received for one or more of the material term-related questions. In this regard, the method may provide for a quality assurance check performed by a second user/assessor once the original assessment inputs have been received. The re-assessment inputs allow for the second user/assessor to change any of the previous assessment inputs (i.e., answers) which they believe are inaccurate.

In response to receiving the assessment inputs, at Event 306, contract term ratings associated with each assessment input are identified. A contract term rating model (i.e., contract term rating database/warehouse) may be implemented that is specific to the contract category and, where applicable, a subcategory. In specific embodiments of the invention, the model is devised such that each assessment input (i.e., answer) is rated “high” , “medium” or “low” in terms of exposure for each category-subcategory combination and each “high”, “medium” and “low” rating are assigned different numerical point values. In addition, each material term-related question may be weighted, using a percentage scale of 0-100% for each category-subcategory combination. In this regard, the weighting of the material term-related question drives the impact that the question has for a specified category-subcategory and is multiplied by the numerical point value of the rating to result in the contract term rating for a particular material term-related question.

At Event 308 a level of exposure (i.e., exposure rating) is determined/calculated for the master contract based on each individual contract term rating. In specific embodiments of the invention, the total numerical points resulting from answers to the material-term questions are divided by the total possible points for category-subcategory to result in the level of exposure (i.e., exposure rating), which is expressed as a percentage. By expressing the level of exposure of the master contract as a percentage of all the possible points, exposure ratings for different contracts can be compared across different category-subcategories.

At Decision 310, a determination is made as to whether the master contract has any subcontracts, otherwise referred to as sub-agreements, amendments, codicils or the like. A master contract may have many subcontracts. If the master agreement does not have any subcontracts, at Event 322, the master contract is queued for exposure decisioning and, subsequent decisioning occurs by one or more designated parties. Decisioning of the exposure of the contract provides for the contract to be accepted as is, remediated/re-negotiated to address the level of exposure, or for the contract to be terminated (i.e., the level of exposure cannot be remediated and/or is of an unacceptable level).

If the determination is made that one or more subcontracts to the master contract exist, at Event 312, a user/assessor is presented with material-related questions pertaining to the subcontract(s) and assessment inputs (i.e., answers) are received. The user/assessor is only required/mandated to provide assessment inputs if material terms are touched upon in the subcontract. In this regard, a subcontract may require the user/assessor to answer/input no questions or a plurality of questions.

At Decision 314, an automated process is undertaken to determine whether the assessment inputs (i.e., answers) provided for the sub-contract differ from the assessment inputs (i.e., answers) provided in the master. If none of the assessment inputs differ, at Event 322 the master contract is queued for exposure decisioning and, subsequent decisioning occurs by one or designated parties.

If the determination is made that one or more assessment inputs provided in the sub-contract differ from the assessment inputs provided in the master, at Decision 316, an automated determination is made as to whether the subcontract amends the master. If the subcontract does not amend the master, at Event 322, the master contract is queued for exposure decisioning and, subsequent decisioning occurs by one or more designated parties.

If the subcontract does amend the master contract, at Event 318, updated contract term ratings, associated with each assessment input (i.e., answer) that differed in the subcontract as compared to the assessment input in the master contract, are identified. Similar to the master contract, the subcontract may implement a contract term rating model/matrix that is specific to the contract category and, where applicable, a subcategory. The numerical point values associated with an inputted assessment/answer may be weighted to drive the impact that the question has for a specified category-subcategory and is multiplied by the numerical point value of the rating to result in the contract term rating for a particular material term-related question. As such, the subcontract may have a stand-alone level of exposure (i.e., exposure rating), referred to as a differential exposure rating score.

At Event 320, the level of exposure (i.e., exposure rating) is re-determined/re-calculated for the master contract based on the updated contract term ratings. The updated contract term ratings may increase or decrease the level of exposure (i.e., exposure rating) of the master contract. It should be noted that a subcontract may terminate/close while the master contract is still active/open and, according to the present invention, the level of exposure (i.e., exposure rating) is automatically re-determined/re-calculated upon the termination of the subcontract to reflect that fact that changes in the contract term ratings of the master due to the subcontract are no longer applicable in the master contract. In addition, new subcontracts may be opened/published during the life of the master contract, which warrant assessment to determine their effect on the level of exposure (i.e., exposure rating) of the master contract.

In response to re-determining/re-calculating the level of exposure (i.e., exposure rating), at Event 322, the master contract is queued for exposure decisioning and, subsequent decisioning occurs by one or more designated parties. To facilitate the decisioning, embodiments of the present invention, provide for presenting a decisioning entity with a user-interface that describes the material terms in plain language, along with the specific rationale documented by the user/assessor during the assessment input process. In addition, in optional embodiments, the user interface may also provide for contract language and specific contract location supporting the assessment input/answer as documented by the user/assessor during the assessment input process.

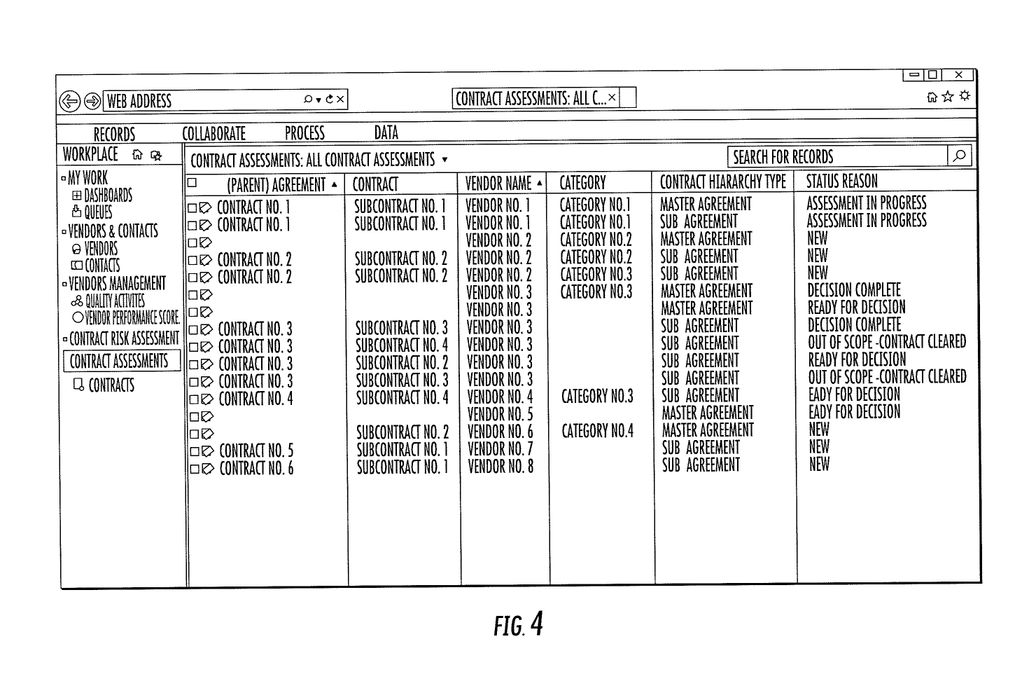

FIGS. 4-15 provide for examples of user interfaces implemented in a module/tool for computational analysis of contracts for identifying and quantifying a level of exposure (i.e., exposure rating). It should be noted that the user interfaces shown and described herein are merely examples and do not limit the scope of the invention. More or less user interfaces may be implemented in the invention herein described without departing from the inventive concepts herein disclosed.

FIG. 4 provides a contract list user-interface that allows a user/assessor to select a contract for assessment and/or view results of previous assessments of selected assessments. Specifically, the contract list user-interface includes a scrollable listing of contracts in which the left-most column lists parent or master contract by name; followed by (left-to-right) a column that lists all contracts (parent/master contracts and subcontracts) by name; followed by a column that lists the name of the vendor/third party entity associated with contract; followed by a column that lists the category and/or subcategory that the contract has been assigned to; followed by a column that lists the contract hierarchy type (i.e., parent/master or sub-agreement/subcontract), followed by the right-most column that lists the assessment status of the contract (i.e., in progress, new contract yet to be assessed, exposure decision completed and the like). In addition, the contract list user-interface provides for selectable options for the user/assessor to view addition user-interfaces/views associated with a user/assessor dashboard and assessment queue; vendor information, contact information; vendor management including a composite vendor performance exposure rating and the like. The composite vendor performance exposure rating provides for an overall vendor exposure rating for all of the contracts associated with a specified vendor and allows the enterprise to compare one vendor to another vendor in terms of the level of exposure that the vendor poses in terms of their respective contracts. Additionally, contract list user-interface provides for a search function, whereby a user/assessor can search, by name, date or the like for a specified contract.

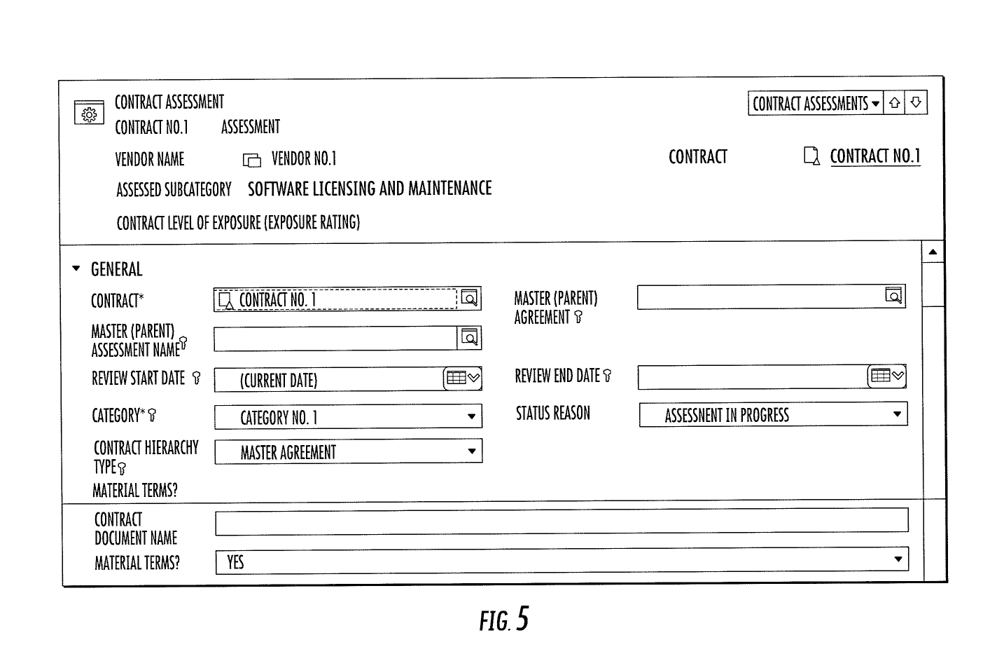

FIG. 5 provides a master contract user-interface that is presented to a user/assessor upon selection of a master/parent contract. In the illustrated example of FIG. 5, the selected contract is awaiting exposure assessment. The contract user-interface provides vendor name, assessment contract category, and, once the assessment has been completed, the contract level of exposure (i.e., exposure rating). In addition the contract hyperlink in the upper right-hand corner, allows the user/assessor to activate the link to access the full contract. Additionally, the contract user interface provides the name of the contract; the name of the parent/master contract, when applicable; the name of (and access to) the parent/master assessment results, when applicable; the assessment/review start data and end date; the contract category and the contract hierarchy type (i.e., master/parent, sub-agreement/subcontract or the like). Additionally, the contract user interface indicates whether the contract includes material terms and, if so, warrants an exposure assessment.

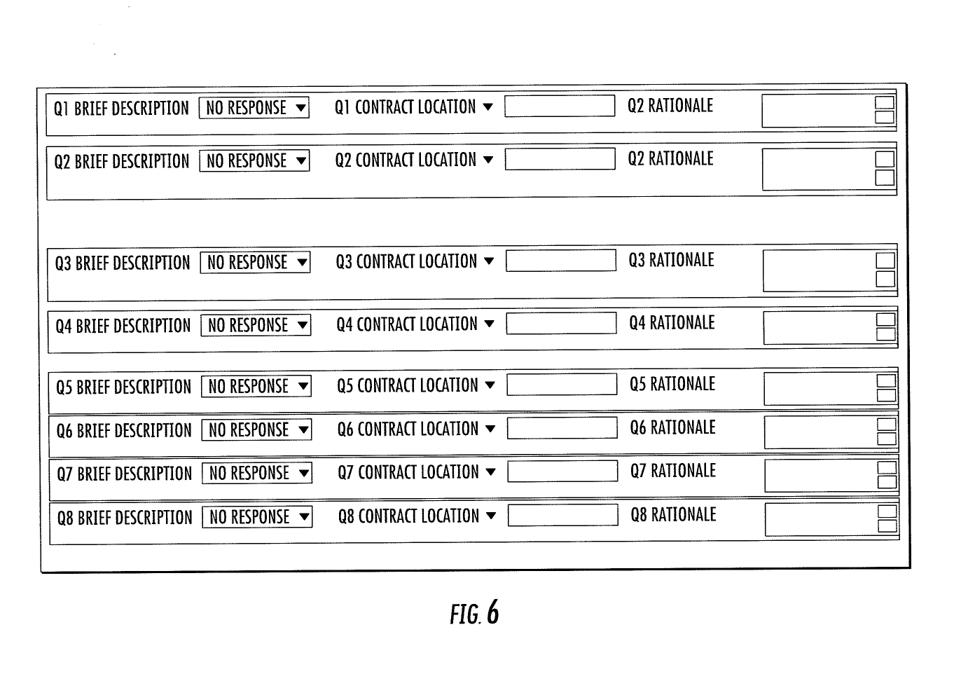

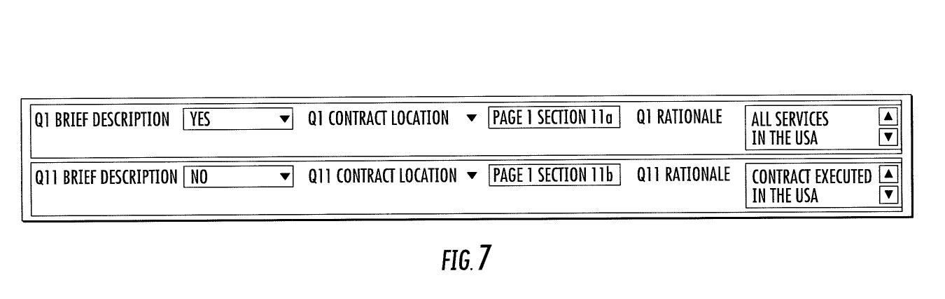

Referring to FIG. 6, an assessment question user-interface is depicted. The assessment question user-interface provides for an abbreviated scrollable listing of all material term-related questions, including a brief description of the question and provides for the user/assessor to input assessment inputs (i.e., answers), as well as contract location and answer rationale for each question. FIG. 7 provides a partial assessment question user-interface in which the questions have been answered.

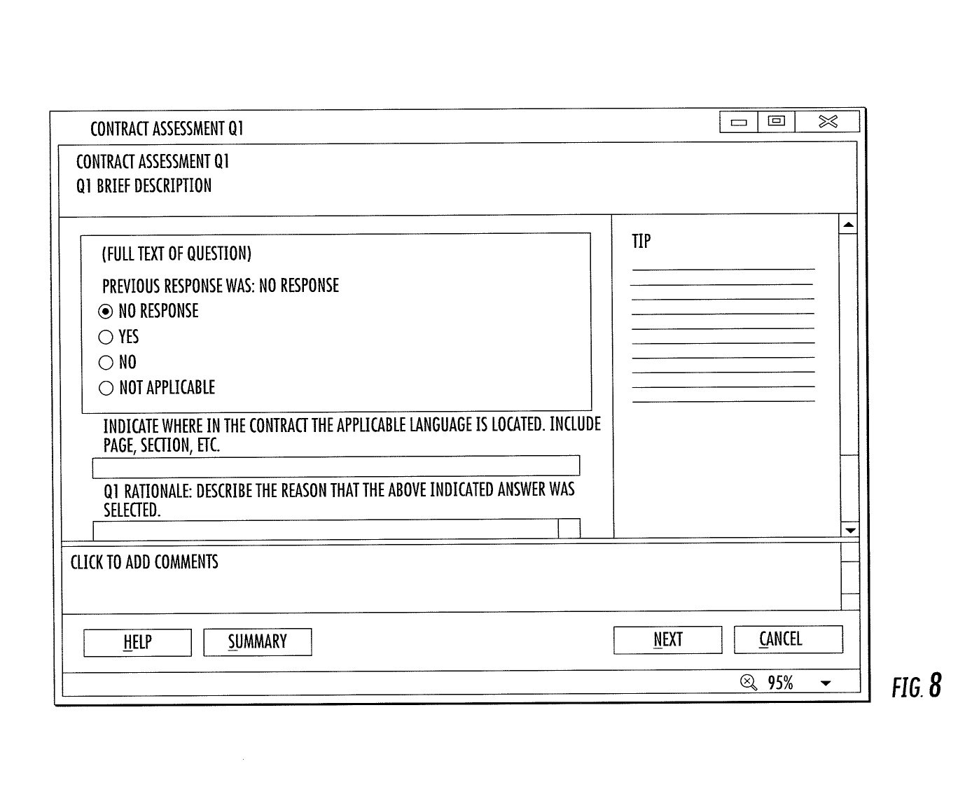

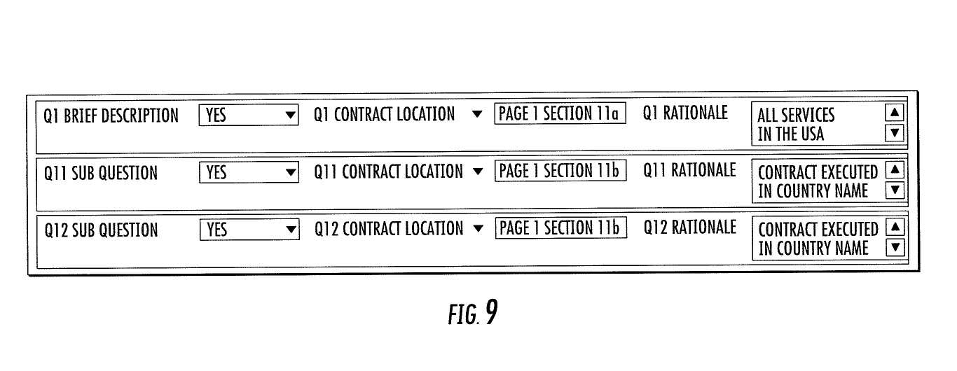

Referring to FIG. 8 a detailed question user-interface that is specific to one particular material-term related question is presented. The detailed view provides for the full text of the question, along with a tip for answering the question, which serves to guide context of the question and guide consistency in the answers from one user/assessor to another. Additionally, the detailed question user-interface provides for input fields for contract location and rationale (i.e., the user/assessor's cognitive reasoning behind the answer), which may be used in subsequent quality assurance assessments and/or future review decisioning. In addition, the detailed question user-interface allows for the user/assessor to input any comments deemed necessary. Once the user/assessor has completed the question, the user/assessor may activate the “next” key to move to the next question in the assessment. FIG. 9 illustrates that specific answers to one question (Question 1) may result in generation of and user-interface appearance of conditional sub-questions (Questions 1.1 and 1.2) which the user/assessor may or may not be required to answer.

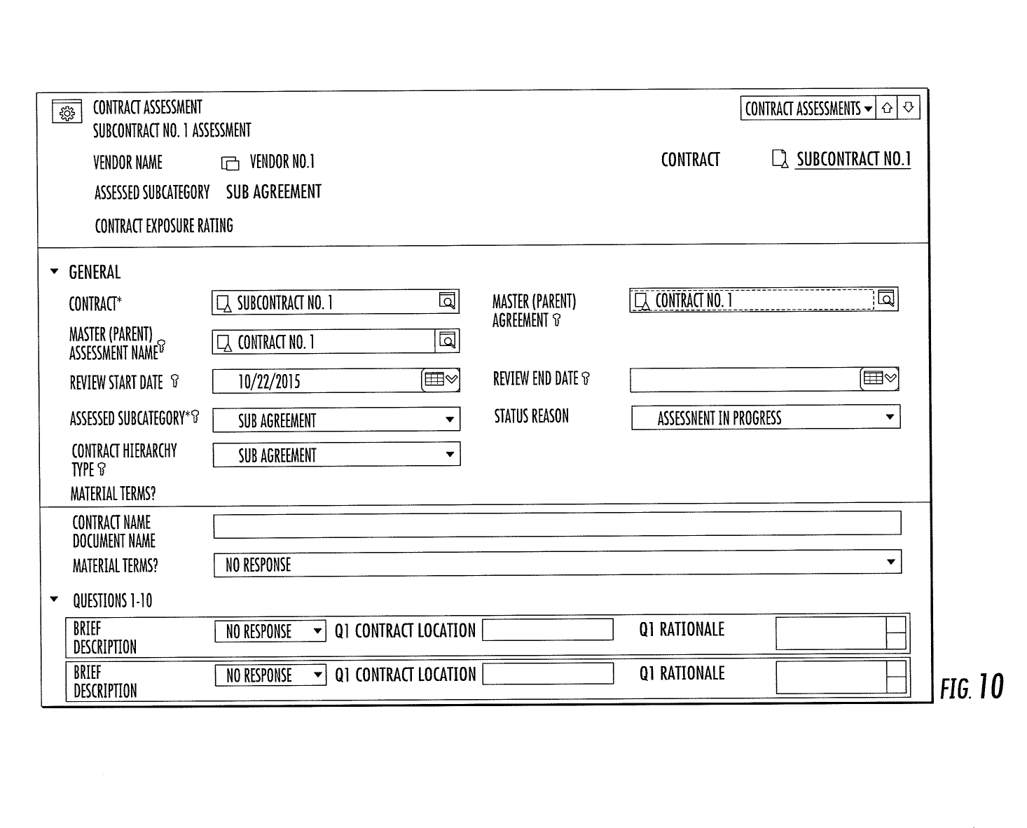

Referring to FIG. 10 a subcontract user-interface is presented to a user/assessor upon selection of a subcontract contract. In the illustrated example of FIG. 10, the selected subcontract contract is awaiting exposure assessment. The subcontract user-interface provides vendor name, assessment contract category, and, once the assessment has been completed, the contract level of exposure (i.e., exposure rating). In addition the contract hyperlink in the upper right-hand corner, allows the user/assessor to activate the link to access the full subcontract. Additionally, the subcontract user interface provides the name of the subcontract; the name of the parent/master contract; the name of (and access to) the parent/master assessment results; the assessment/review start data and end date; the contract category of the subcontract and the contract hierarchy type (i.e., sub-agreement/subcontract). Additionally, the subcontract user interface indicates whether the subcontract includes material terms and, if so, warrants an exposure assessment. In addition the applicable questions (Questions 1-10) that touch upon material terms are presented in abbreviated format.

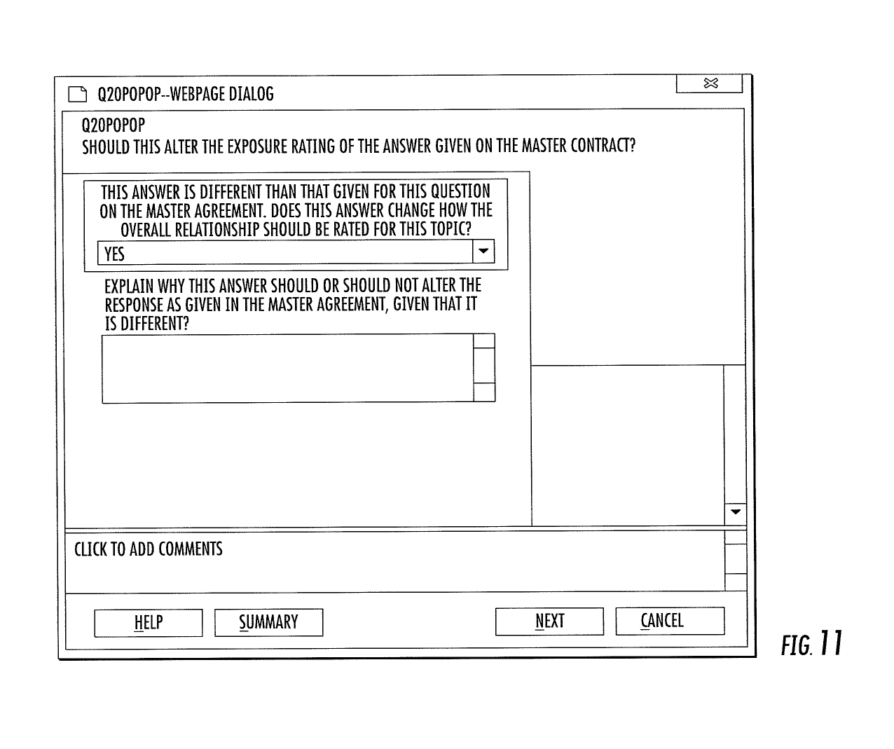

FIG. 11 provides an impact to master contract user-interface in which the user/assessor is provided with determination as to whether the answer to a question in the subcontract assessment should alter the exposure rating of the answer provided for on the master contract. If the answer provided on the subcontract differs from the answer provided on the master agreement, the user/assessor is required to determine whether the subcontract amends the master. In addition, an input field is provided for the user/assessor to state the rationale for determining whether the answer does or does not alter the answer provided in the master contract and, thus alter the exposure rating.

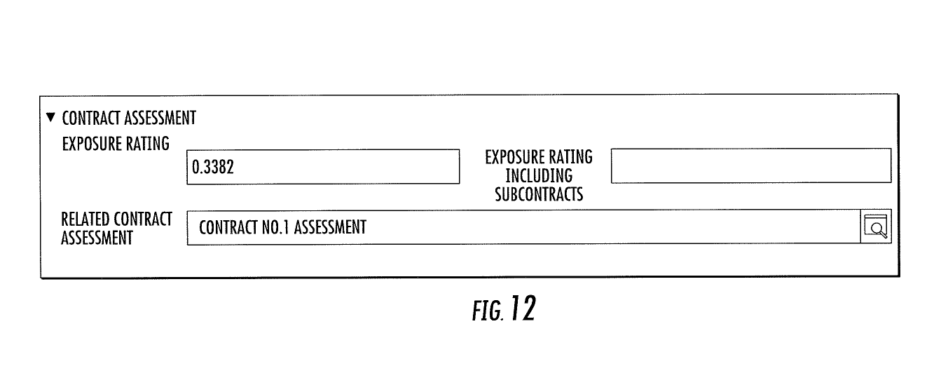

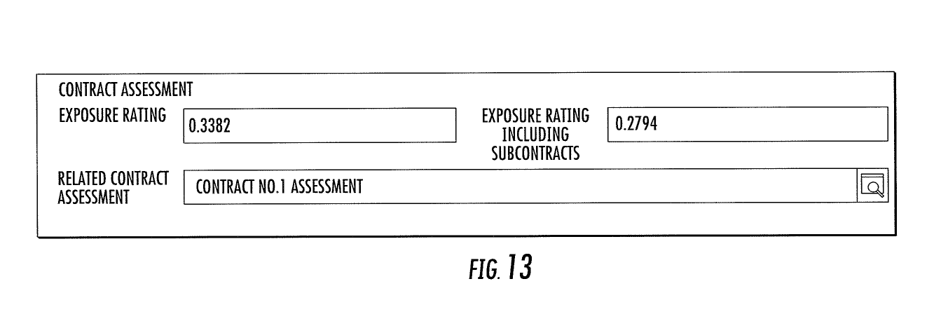

FIG. 12 provides an exposure rating user-interface that indicates the exposure rating for the master contract. The exposure rating may be generated in response to the user/assessor completing all of the required/mandatory assessment questions and, when applicable, completion of the quality assurance check/verification. In addition, the user interface provides a hyperlink to the related contract's detailed assessment results. FIG. 13 provides the exposure rating user-interface that indicates both the rating for the master contact (i.e., absent consideration of the subcontracts) and the exposure rating for the master contract taking into account all of the subcontracts. In the illustrated example, the exposure rating decreases from 0.3382 to 0.2794 when taking into account all of the subcontracts associated with the master contract.

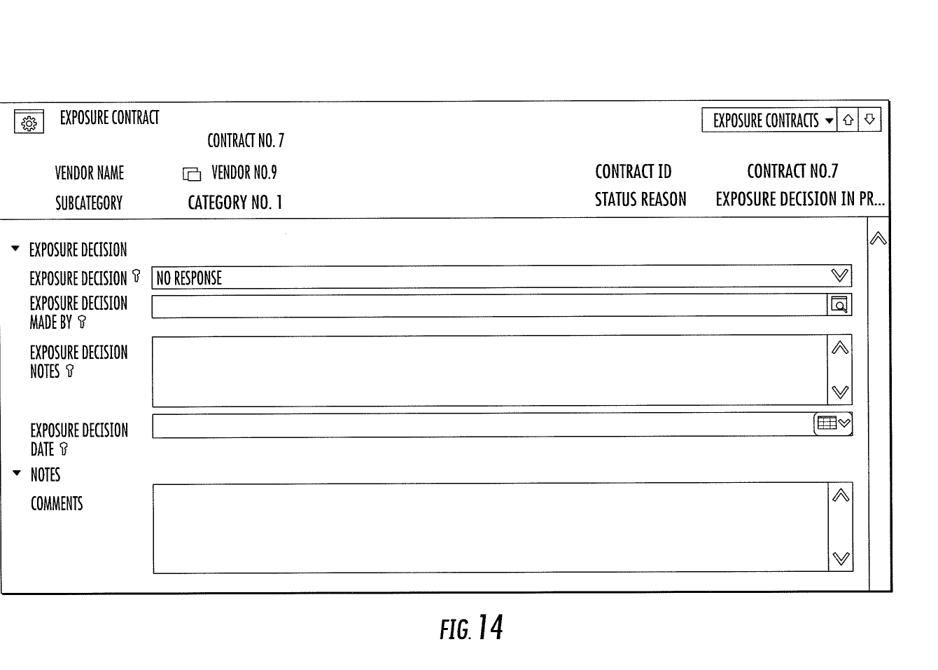

Referring to FIG. 14 an exposure decision user-interface is highlighted in which a decisioning entity can provide a requisite decision (e.g., approve, remediate, terminate or the like) for the contract based on the exposure rating and provide further details associated with the decision, a data on which the decision was made and any further notes/comments.

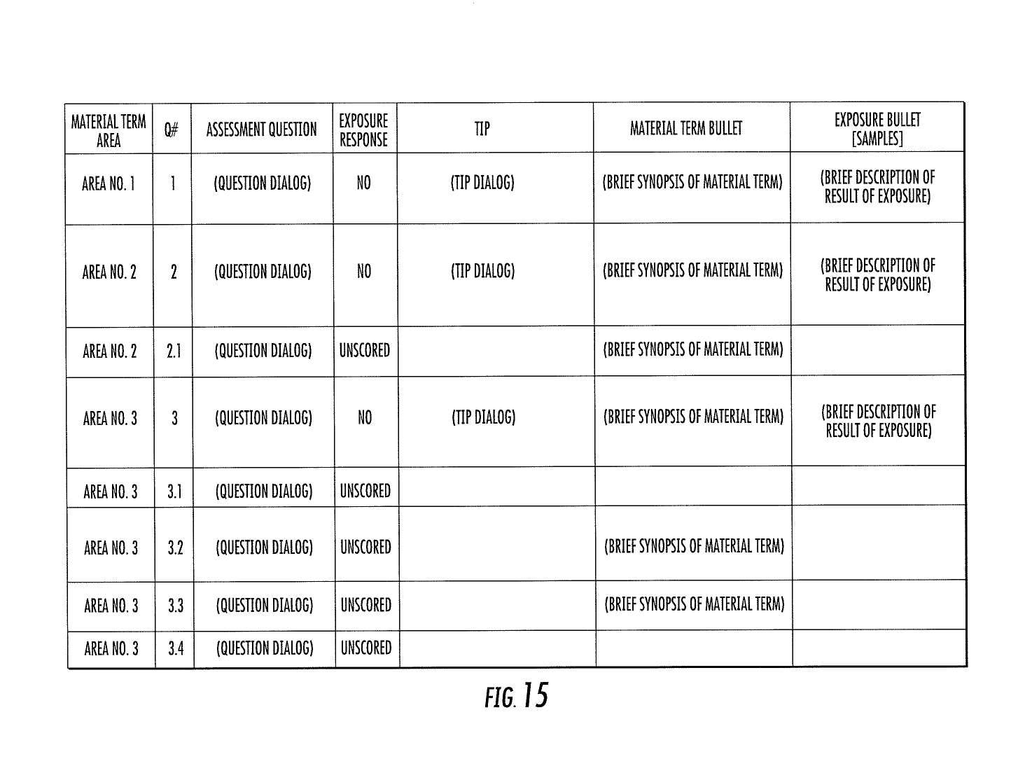

FIG. 15 provides a user-interface that provides details of an exposure assessment for a specified contract. The details include question number, material term area of the question, assessment answer, the tip provided for answering the question, a brief synopsis in plain language of the material term in the contract and a brief description of the exposure resulting from the material term.

Thus, systems, apparatus, methods, and computer program products described above provide for computational analysis of resources, such as contracts, and resolution of non-conforming attributes, such as material terms of the contracts. In this regard, resources are assessed/evaluated to identify a plurality of attributes associated with a resource of a specified resource category and a core resource attribute database is accessed to determine the deviation of the attributes associated with the resource to the core attributes for the identified resource category. In response to determining the deviation between the attributes associated with the resource and the core attributes, an overall level of deviation is determined for the resource and, in response to determining the level of deviation, a resolution scenario is invoked for the resource based on the level of deviation.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for computational analysis of resources to determine attribute deviation from core resource attributes, the system comprising:
a core resource attribute database configured to store, in first memory, a plurality core attributes for each of a plurality of resource categories;
an apparatus including a computing platform having a second memory and at least one processor device in communication with the second memory;
a resource analytics module stored in the second memory, executable by the processor device, and configured to:
receive a plurality of first inputs that assess a plurality of attributes associated with a resource of an identified resource category;
access the core resource attribute database to determine deviation of the attributes associated with the resource to the core attributes for the identified resource category;
determine a level of deviation for the resource based on the determined deviation of the attributes associated with the resource to the core resource attributes; and
in response to determining the level of deviation, invoke a resolution scenario for the resource based on the level of deviation.

2. The system of claim 1, further comprising a central reporting repository configured to store, in a third memory, the resolution scenario for each of a plurality of resources.

3. The system of claim 2, further comprising a requirement rules database configured to store, in fourth memory, a plurality of compliance requirement rules associated each of the plurality of resource categories.

4. The system of claim 3, wherein the central reporting repository is further configured to access the requirement rules database to apply compliance requirement rules applicable to the identified resource category of the resource and, based on application of the compliance requirement rules, transform the resource to comply with the compliance requirement rules.

5. The system of claim 1, wherein the resource analytics module is further configured to:
receive one or more second inputs that assess one or more attributes associated with a sub-resource associated with the resource;
determine that at least one of the one or more second inputs result in a conflict between one or more attributes associated with the sub-resource and one or more attributes associated with the resource; and
determine the level of deviation for the resource based on the conflict between one or more attributes associated with the sub-resource and one or more attributes associated with the resource.

6. A system for computational analysis of contracts for identifying contract exposure, the system comprising:
a contract term rating database that is configured to store, in first memory, contract term ratings for a plurality of material contract terms based on an associated contract category;
an apparatus including a computing platform having a second memory and at least one processor device in communication with the second memory;
a contracts analytics module stored in the second memory, executable by the processor device, and configured to:
receive a plurality of first inputs that assess a plurality of material terms associated with a contract of an identified contract category;
access the contract term rating database to determine, based on the first inputs, contract term ratings for one or more of the plurality of material terms associated with the contract; and
determine a quantifiable level of exposure for the contract based on the contract term ratings.

7. The system of claim 6, wherein the contracts analytics module is further configured to receive the plurality of first inputs, wherein the first inputs include (i) answers to a plurality of material term-related questions, (ii) a location in the contract that supports a corresponding answer to a material term-related question, and (iii) rationale for a corresponding answer to a material term-related question.

8. The system of claim 7, wherein the contracts analytics module is further configured to receive the plurality of first inputs, wherein the first inputs include (iii) the rationale for the corresponding answer to the material term-related question, wherein the rationale includes (a) cognitive process behind the corresponding answer, and (b) the specific language in the contract that supports the corresponding answer.

9. The system of claim 6, wherein the contract term rating database is configured to store, in the first memory, the contract term ratings for the plurality of material contract terms based on the associated contract category, wherein each contract term rating is a pre-determined weighted value based on a relative importance of the material contract term to the associated contract category.

10. The system of claim 7, wherein the contracts analytics module is further configured to determine the quantifiable level of exposure for the contract, in real-time, in response to receiving each of the answers to the plurality of material-term related questions.

11. The system of claim 6, wherein the contracts analytics module is further configured to receive one or more of second inputs that re-assess one or more of the plurality of material terms associated with the contract.

12. The system of claim 6, wherein the contracts analytics module is further configured to:
receive one or more of second inputs that assess one or more of the plurality of material terms associated with a sub-contract of the contract;
determine that at least one of the one or more second inputs result in a conflict between one or more material terms associated with the sub-contract and one or more material terms associated with the contract;
access the contract term rating database to determine, based on the conflict, contract term ratings for one or more of the plurality of material terms associated with the sub-contract; and
in response to confirming that that the sub-contract amends the contract, re-determine the quantifiable level of exposure for the contract based on the contract term ratings for one or more of the plurality of material terms associated with the sub-contract.

13. The system of claim 12, wherein the contracts analytics module is further configured to re-determine the quantifiable level of exposure, in real-time, in response to one or more events that change a status of the contract or the sub-contract.

14. The system of claim 6, wherein the contracts analytics module is further configured to present the quantifiable level of exposure and first inputs to a decisioning entity and receive one or more second inputs from the decisioning entity that determines if the contract is (i) acceptable as is, (ii) requires remediation, or (iii) requires termination of the contract.

15. A computer program product comprising:
a non-transitory computer-readable medium comprising:
a first set of codes for causing a computer receive a plurality of first inputs that assess a plurality of material terms associated with a contract of an identified contract category;
a second set of codes for causing a computer to access a contract term rating database to determine, based on the first inputs, contract term ratings for one or more of the plurality of material terms associated with the contract; and
a third set of codes for causing a computer to determine a quantifiable level of exposure for the contract based on the contract term ratings.

16. The computer program product of claim 15, wherein the first set of codes is further configured to receive the plurality of first inputs, wherein the first inputs include (i) answers to a plurality of material term-related questions, (ii) a location in the contract that supports a corresponding answer to a material term-related question, and (iii) rationale for a corresponding answer to a material term-related question.

17. The computer program product of claim 16, wherein the first set of codes is further configured to receive the plurality of first inputs, wherein the first inputs include (iii) the rationale for the corresponding answer to the material term-related question, wherein the rationale includes (a) cognitive process behind the corresponding answer, and (b) the specific language in the contract that supports the corresponding answer.

18. The computer program product of claim 15, wherein the second set of codes is further configured to access the contract term rating database to determine, based on the first inputs, the contract term ratings, wherein each contract term rating is a pre-determined weighted value based on a relative importance of the material contract term to the associated contract category.

19. The computer program product of claim 16, wherein the third set of codes is further configured to determine the quantifiable level of exposure for the contract, in real-time, in response to receiving each of the answers to the plurality of material-term related questions.

20. The computer program product of claim 15, wherein the computer-readable medium further includes:
a fourth set of codes for causing a computer to receive one or more of second inputs that assess one or more of the plurality of material terms associated with a sub-contract of the contract;
a fifth set of codes for causing a computer to determine that at least one of the one or more second inputs result in a conflict between one or more material terms associated with the sub-contract and one or more material terms associated with the contract;
a sixth set of codes for causing the computer to access the contract term rating database to determine, based on the conflict, contract term ratings for one or more of the plurality of material terms associated with the sub-contract; and
a seventh set of codes for causing a computer to, in response to confirming that that the sub-contract amends the contract, re-determine the quantifiable level of exposure for the contract based on the contract term ratings for one or more of the plurality of material terms associated with the sub-contract.
